(19) United States
(12) Patent Application Publication
(10) Pub. No.: US 2008/0278698 A1
(43) Pub. Date: Nov. 13, 2008

(54) Lithographic apparatus and method

(75) Inventors: Robert Kazinczi, Helmond (NL); Wim Tjibbo Tel, Helmond (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/797,902

(22) Filed: May 8, 2007

(51) Int. Cl. G03B 27/42

(52) U.S. Cl. 355/44; 355/53

(57) ABSTRACT

A lithographic method is provided and comprises using an illumination system to provide a beam of radiation having an illumination mode, using a patterning device to impart the radiation beam with a pattern in its cross-section, and projecting the patterned radiation beam onto a plurality of substrates. The illumination mode is adjusted after the radiation beam has been projected onto one or more substrates. The adjustment is arranged to reduce the effect of aberrations due to lens heating on the projected pattern during projection of the pattern onto one or more subsequent substrates.

### BACKGROUND

The present invention relates to a lithographic apparatus and method.

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

Typically, projection of the pattern onto the substrate is performed by directing the pattern through a projection system. The projection system comprises a series of lenses, and is arranged to project the pattern with high precision, i.e. introducing only small amounts of distortion or other errors into the projected pattern. In conventional operation of a lithographic apparatus, a multiplicity of substrates are patterned in series, one after another. Over time the projection system will heat up, due to absorption of the radiation which passes through it during projection of the pattern. This heating causes the shapes of the lenses to change, thereby causing aberrations to occur which distort the pattern projected onto the substrate.

The aberrations may be corrected by using actuators to adjust the shapes of the lenses. However, this correction only works to a limited extent. There is a tendency in lithography towards using illumination modes in which radiation is increasingly concentrated over smaller areas during projection by the projection system. This concentration of the radiation increases the extent to which lenses of the projection system are heated by the radiation. This in turn increases the distortion of the projected pattern.

It is desirable to provide a lithographic apparatus and method which reduces or mitigates the above problem.

### SUMMARY

According to an aspect of the invention, there is provided a lithographic method comprising using an illumination system to provide a beam of radiation having an illumination mode, using a patterning device to impart the radiation beam with a pattern in its cross-section, and projecting the patterned radiation beam onto a plurality of substrates, wherein the illumination mode is adjusted after the radiation beam has been projected onto one or more substrates, the adjustment being arranged to reduce the effect of aberrations due to lens heating on the projected pattern during projection of the pattern onto one or more subsequent substrates.

According to a further aspect of the invention there is provided a lithographic apparatus comprising an illumination system for providing a beam of radiation having an illumination mode, a support structure for supporting a patterning device, the patterning device serving to impart the radiation beam with a pattern in its cross-section, a substrate table for holding a substrate, and a projection system for projecting the patterned radiation beam onto a target portion of the substrate, wherein the apparatus further comprises a controller arranged to control part of the illumination system, the controller being arranged to adjust the illumination mode of the radiation beam after the radiation beam has been projected onto one or more substrates, the adjustment being arranged to reduce the effect of aberration due to lens heating on the projected pattern during projection of the pattern onto one or more subsequent substrates.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 schematically illustrates the transformation of an angular intensity distribution to a spatial intensity distribution according to a prior art arrangement;

FIG. 3 schematically illustrates in more detail part of the lithographic apparatus shown in FIG. 1;

FIG. 4 depicts a spatial intensity distribution in a pupil plane;

FIGS. 5a and 5b are top and perspective views, respectively, which schematically illustrate a mirror of a mirror array which may form part of the lithographic apparatus shown in FIG. 1;

FIG. 6 schematically depicts elements of the lithographic apparatus shown in FIG. 1 which are of relevance to the embodiment of the invention;

FIG. 7 is a flow chart which shows processes used by the embodiment of the invention;

FIGS. 8a to 10b are schematic illustrations of illumination mode adjustments which may form part of the embodiment of the invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device.”

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual-stage) or more substrate tables (and/or two or more support structures). In such “multiple stage” machines the additional tables may be used in parallel, or preparatory steps may be carried out on one or more tables while one or more other tables are being used for exposure.

The lithographic apparatus may be of a type which allows rapid switching between two or more masks (or between patterns provided on a controllable patterning device), for example as described in Published U.S. Patent Application No. 2007-0013890A1.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

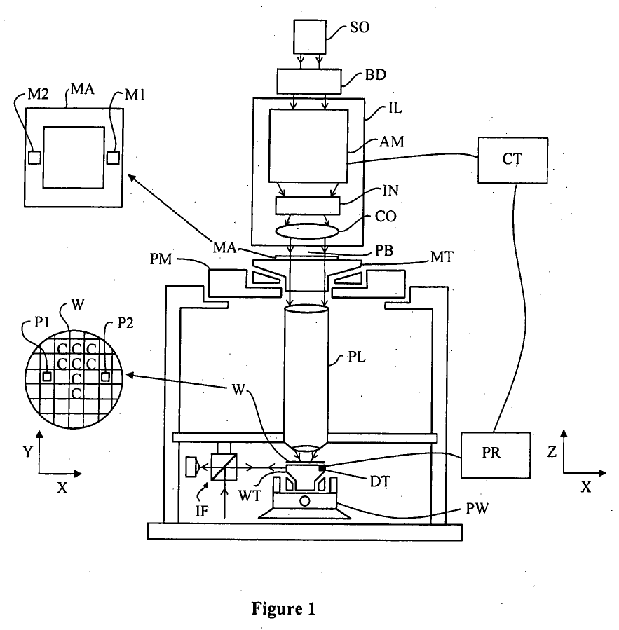

FIG. 1 schematically depicts a lithographic apparatus according to a particular embodiment of the invention. The apparatus comprises:
an illumination system (illuminator) IL to condition a radiation beam PB of radiation (e.g. UV radiation or EUV radiation);
a support structure (e.g. a support structure) MT to support a patterning device (e.g. a mask) MA and connected to first positioning device PM to accurately position the patterning device MA with respect to item PL;
a substrate table (e.g. a wafer table) WT for holding a substrate (e.g. a resist-coated wafer) W and connected to a second positioning device PW for accurately positioning the substrate with respect to item PL; and
a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source SO and the lithographic apparatus may be separate entities, for example when the source SO is an excimer laser. In such cases, the source SO is not considered to form part of the lithographic apparatus and the radiation beam B is passed from the source SO to the illuminator IL with the aid of a beam delivery system BD comprising for example suitable directing mirrors and/or a beam expander. In other cases, the source SO may be an integral part of the apparatus, for example when the source SO is a mercury lamp. The source SO and the illuminator IL, together with the beam delivery system BD if required, may be referred to as a radiation system.

The illuminator IL is described further below.

Upon leaving the illuminator IL, the radiation beam PB is incident on the patterning device (e.g. mask) MA, which is held on the support structure MT. Having traversed the patterning device MA, the radiation beam PB passes through the lens PL, which focuses the beam PB onto a target portion C of the substrate W. With the aid of the second positioning device PW and position sensor IF (e.g. an interferometric device), the substrate table WT can be moved accurately, e.g. so as to position different target portions C in the path of the radiation beam PB. Similarly, the first positioning device PM and another position sensor (which is not explicitly depicted in FIG. 1) can be used to accurately position the patterning device MA with respect to the path of the radiation beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following exemplary modes:

1. In step mode, the support structure MT and the substrate table WT are kept essentially stationary, while an entire pattern imparted to the radiation beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

The illuminator IL may comprise adjusting means AM for adjusting the angular intensity distribution of the radiation beam PB. This may allow adjustment of for example, the outer and/or inner radial extent (commonly referred to as σ-outer and σ-inner, respectively) of the intensity distribution in a pupil plane of the illuminator IL. In addition, the illuminator IL generally comprises various other components, such as an integrator IN and coupling optics CO. The integrator, which may for example be a quartz rod, improves the homogeneity of the radiation beam PB.

The spatial intensity distribution of the radiation beam PB at the illuminator pupil plane is converted to an angular intensity distribution before the radiation beam PB is incident upon the patterning device (e.g. mask) MA. In other words, there is a Fourier relationship between the pupil plane of the illuminator IL and the patterning device MA (the patterning device is in a field plane). This is because the illuminator pupil plane substantially coincides with the front focal plane of the coupling optics CO, which focus the radiation beam PB to the patterning device MA.

Selection of an appropriate spatial intensity distribution at the pupil plane can be used to improve the accuracy with which an image of the patterning device MA is projected onto a substrate W. In particular, spatial intensity distributions with dipole, annular or quadrupole off-axis illumination profiles may be used to enhance the resolution with which the pattern is projected, or to improve other parameters such as sensitivity to projection lens aberrations, exposure latitude and depth of focus.

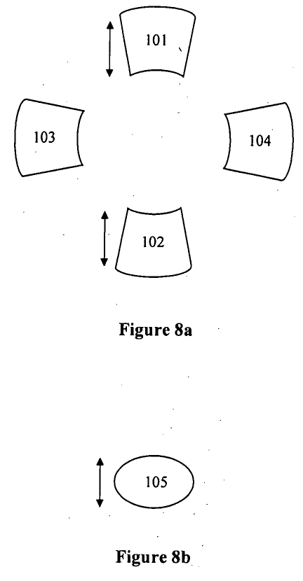

A detector DT is provided in the substrate table WT, and is arranged to measure aberrations present in the radiation beam PB. The detector DT is connected via a processor PR to a controller CT. The controller CT is arranged to adjust settings of the illuminator IL in response to signals received from the measurement system. The manner in which this is done is described further below in relation to FIG. 6.

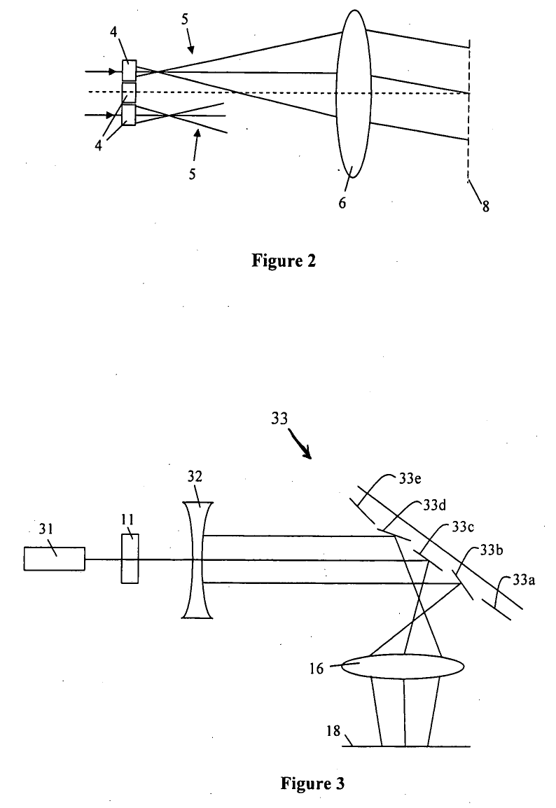

FIG. 2 schematically illustrates the principle of corresponding angular and spatial intensity distributions of a radiation beam PB. According to a prior-art arrangement, the outer and/or inner radial extent of the radiation beam (σ-outer and σ-inner respectively) may be set using an array of diffractive elements 4. Each diffractive element 4 forms a divergent pencil 5 of rays. Each pencil 5 of rays corresponds to a part or sub-beam of the radiation beam PB. The pencils 5 will be incident at a focusing lens 6. In the back focal plane 8 of the focusing lens 6, each pencil 5 corresponds to an illuminated area. The size of the area depends on the range of directions into which the rays of the pencil 5 propagate. If the range of directions is small, the size of the illuminated area in the back focal plane 8 is also small. If the range of directions is large, the size of the illuminated area in the back focal plane 8 is also large. Furthermore, all identical directions of the pencils 5, i.e. all rays which are parallel to each other, correspond to the same particular point in the back focal plane 8 (provided that ideal optical conditions apply).

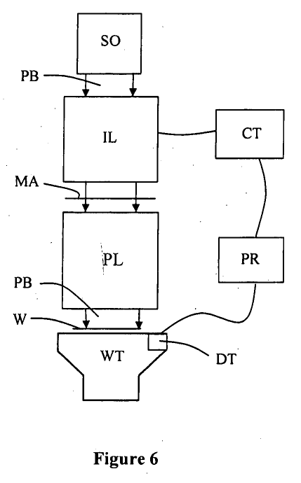

It is known to produce a spatial intensity distribution in a cross-section of the radiation beam PB (in particular in a pupil plane of the radiation beam PB) which has an annular shape. This is known as an annular illumination mode. An example of this annular shape is illustrated in FIG. 4 by two concentric circles. The inner radial extent (σ-inner) of the annular shape corresponds to the central area with an intensity of zero or close to zero, and can be set by using an appropriate array of diffractive optical elements. For example, referring to FIG. 2 an array of diffractive elements 4 can be selected which is configured such that none of the pencils 5 of rays will be incident at the central area, and will instead only be incident in the annular area (although in practice, there may be an intensity greater than zero in the central area, due to effects such as dispersion). By appropriate selection of the diffractive element array 4, other spatial intensity distributions can be produced in the cross-sectional area, such as dipole or quadrupole illumination. Additional optical elements (not illustrated) such as a zoom lens or an axicon may be used to apply further modifications to the angular distribution of the radiation beam PB.

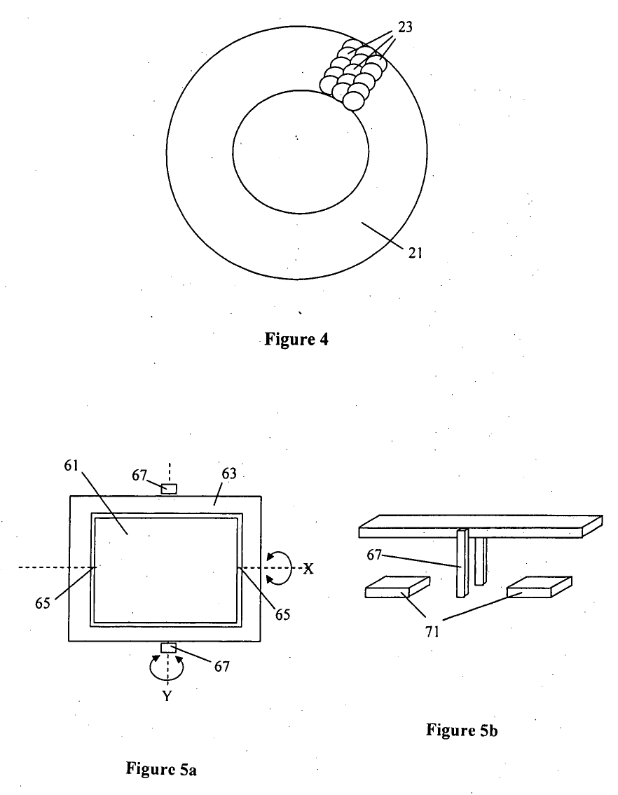

FIG. 3 schematically shows an alternative prior art arrangement. A source 31 (equivalent to SO in FIG. 1) outputs a relatively narrow, collimated radiation beam which passes through a shutter 11. It is then passed through beam divergence optics 32 which expand the beam to a size which corresponds to the size of an array 33 of reflective elements 33a, 33b, 33c, 33d, 33e. Ideally, the radiation beam divergence optics 32 should output a collimated beam. Preferably, the size of the expanded radiation beam is sufficient that the radiation beam is incident at all reflective elements 33a to 33e. In FIG. 3, by way of example, three sub-beams of the expanded radiation beam are shown.

A first sub-beam is incident at reflective element 33b. Like the other reflective elements 33a and 33c to 33e of the array 33, the reflective element 33b can be controlled to adjust its orientation so that the sub-beam is reflected in a desired predetermined direction. Redirecting optics 16, which may comprise a focusing lens, redirect the sub-beam so that it is incident at a desired point or small area in a cross-sectional plane 18 of the radiation beam. The cross-sectional plane 18 may coincide with a pupil plane, which acts as a virtual radiation source for other parts of the illuminator (not shown in FIG. 3). The other sub-beams shown in FIG. 3 are reflected by the reflective elements 33c, 33d and redirected by redirecting optics 16 so as to be incident at other points of plane 18. By controlling the orientations of the reflective elements 33a to 33e, almost any spatial intensity distribution in the cross-sectional plane 18 can be produced.

Although FIG. 3 shows only five reflective elements 33a-e, the array 33 may comprise many more reflective elements, for example arranged in a two-dimensional grid. For example, the array 33 may comprise 1024 (e.g. 32×32) mirrors, or 4096 (e.g. 64×64) mirrors, or any other suitable number of mirrors. More than one array of mirrors may be used. For example a group of four mirror arrays having 32×32 mirrors may be used. In the following text, the term ‘array’ may mean a single array or a group of mirror arrays.

FIG. 4 shows a spatial intensity distribution in a pupil plane which may be produced by the illuminator IL of the lithographic apparatus. FIG. 4 may be understood as a schematic diagram which illustrates the principle of producing a spatial intensity distribution using a plurality of sub-beams. The drawing plane of FIG. 4 coincides with a cross-section of the radiation beam PB, for example, the cross-sectional plane 18 of FIG. 3. FIG. 4 depicts fifteen circular areas 23 which represent areas with an illumination intensity greater than a threshold value. The intensity distribution shown in FIG. 4 has approximately the shape of a parallelogram. Since the sub-beams of the radiation beam PB can be directed to any desired place of the cross-sectional area, almost any intensity profile can be produced. However, it is also possible to produce what could be considered to be conventional intensity distributions, e.g. with an annular shape, with a dipole shape, quadrupole shape, etc. In FIG. 4, the area 21 in between the inner and outer circles can be filled with circular areas 23. The σ-outer and σ-inner can be adjusted by directing the sub-beams to the corresponding places between the inner circle and the outer circle.

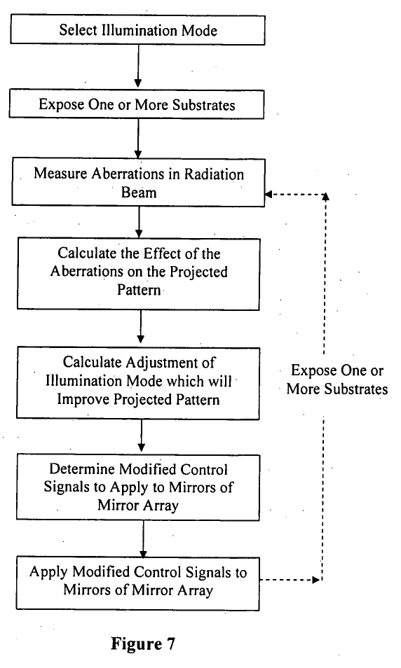

FIGS. 5a and 5b show schematically an example of a reflective element, which may for example form part of the array 33 of reflective elements shown schematically in FIG. 3. The array of reflective elements may comprise for example more than 1000 of such reflective elements, which may for example be arranged in a grid-like formation in a plane which crosses through a radiation beam. The reflective element is viewed from above in FIG. 5a and in a perspective view in FIG. 5b. For ease of illustration some of the detail shown in FIG. 5a is not included in FIG. 5b. The reflective element comprises a mirror 61 with a rectangular reflective surface area. In general, the mirror 61 can have any desired shape, for example square, rectangular, circular, hexagonal, etc. The mirror 61 is connected to a support member 63 via a rotational connection 65. The mirror 61 may be rotated with respect to the support member 63, the rotation being around a first axis X (indicated by a dashed line). The support member 63 is rotationally connected to legs 67 which are supported by a substrate (not shown). The support member 63 may be rotated around a second axis Y (indicated by a dashed line). It is therefore possible to orientate the mirror 61 in directions which require a combination of X-axis and Y-axis rotations.

The orientation of the mirror 61 may be controlled using electrostatic actuators 71. The electrostatic actuators 71 comprise plates to which predetermined charges are applied. The charges attract the mirror 61 via electrostatic attraction, and are varied to adjust the orientation of the mirror 61. Sensors may be provided to give feedback control of the orientation of the mirror 61. The sensors may for example be optical sensors, or may for example be capacitive feedback sensors. The plates which are used as electrostatic actuators may also act as the capacitive feedback sensors. Although only two electrostatic actuators 71 are shown in FIG. 5b, more than two may be used. Any other suitable form of actuator may be used. For example piezo-electric actuators may be used.

The orientation of the mirror 61 can be adjusted so as to reflect an incident radiation beam into any desired direction of a hemisphere. Further details concerning reflective elements of the type shown in FIGS. 5a and 5b, and of other types, are disclosed in for example U.S. Pat. No. 6,031,946.

FIG. 6 is a simplification of FIG. 1, and shows some elements of the lithographic apparatus which are of relevance to an embodiment of the invention. As described further above, the source SO may for example comprise a laser arranged to direct a radiation beam PB to the illuminator IL. The illuminator IL may include an array of mirrors which are arranged to provide a required illumination mode in the manner described above. The illuminator IL is arranged to direct radiation with a desired mode onto the mask MA, which applies a pattern onto the radiation beam PB. The projection system PL, which may comprise a set of refractive lenses, is arranged to project the pattern onto a substrate W supported on a substrate table WT.

The detector DT is arranged to measure aberrations in the radiation beam. The detector DT is connected via the processor PR to the controller CT. The controller CT controls the orientation of the mirror array provided within the illuminator IL.

In use, the lithographic apparatus is arranged to project a pattern onto a multiplicity of substrates in series. During projection of the pattern onto the substrates, the majority of radiation will pass through the projection system PL and be incident upon the substrate W. However, a small proportion of the radiation will be absorbed by the lenses within the projection system PL, causing the lenses to heat up. This is a known effect, and is often referred to as lens heating. The rate at which the lenses get hotter decreases over time, until eventually the temperature of the lenses stabilizes (this is sometimes referred to as saturation). In a typical lithographic apparatus the temperature of the lenses may stabilize after for example 15 minutes (the time period is different for different apparatus). Stabilization of the lens temperature occurs once the lenses dissipate the heat provided by the radiation beam at a rate which is the same as the rate at which heat is added to the lenses by the radiation beam.

Heating of the lenses may cause aberrations to be introduced into the pattern being projected onto the substrate table WT. The detector DT provided in the substrate table is arranged to detect these aberrations. The detector DT may for example be a shearing interferometer, which is arranged to introduce shear into the radiation beam and then measure wavefronts of the radiation beam. It is not essential that the detector DT be a shearing interferometer; any suitable detector may be used. The detector DT may be moved transverse to the radiation beam PB in order to allow the aberration present in different parts of the radiation beam to be measured. This is achieved by moving the substrate table WT upon which the substrate W is located.

Aberration data output by the detector DT passes to the processor PR. The processor PR uses this data to form a representation of the distribution of aberrations in the radiation beam. The processor PR then determines the effect of the aberrations upon the pattern projected onto the substrate W. In order to do this, the processor PR is provided with a representation of the pattern on the mask MA. This may for example be stored in a storage device such as a memory, which may form part of the processor PR. Once the processor PR has determined the effect of the aberrations upon the pattern projected onto the substrate W, it then calculates an adjustment of the illumination mode which may be used to improve the fidelity of the pattern projected onto the substrate W. In other words, an illumination mode adjustment is calculated such that the projected pattern will be more accurate than the pattern which would have been projected in the absence of the illumination mode adjustment.

Once a desired adjustment of the illumination mode has been determined, this information is passed to the controller CT. The controller CT determines adjustments needed to the orientations of the mirrors, and alters control signals sent to the mirrors of the mirror array accordingly.

The formation of the representation of the distribution of aberrations in the radiation beam, and the determination of the effect of the aberrations upon the pattern projected onto the substrate W are described above as two separate steps. However, the processor PR may perform these as a single step.

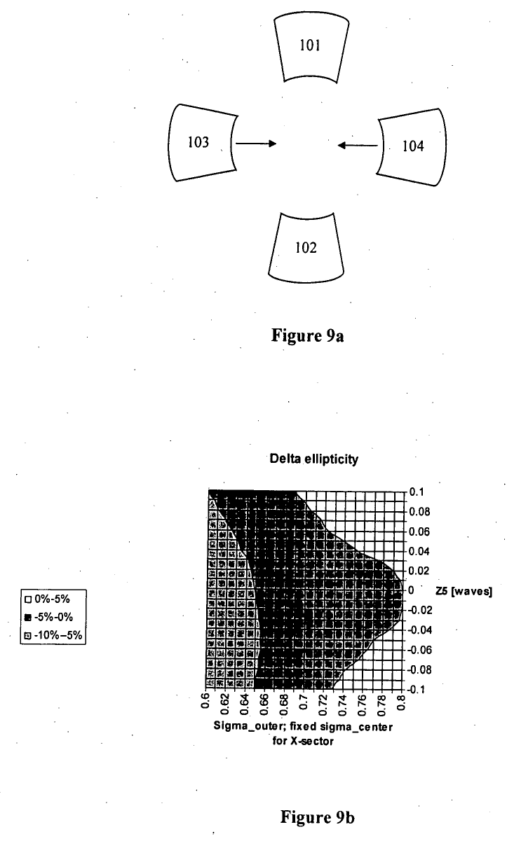

FIG. 7 is a flow chart which sets out the processes described above. An illumination mode is selected, the illumination mode being one which is appropriate for the pattern to be projected. The pattern is projected onto one or more substrates. Aberrations present in the radiation beam are measured. The effect of the aberrations on the projected pattern is calculated or otherwise determined. An adjustment of the illumination mode which improves the accuracy of the pattern projected onto the substrate is calculated. Required modifications of the control signals sent to mirrors of the mirror array are determined, and the modified control signals are applied to the mirrors.

As explained above, lenses in the projection system PL will continue to heat up over a considerable period of time. For this reason, the processes set out in FIG. 7 are repeated after a predetermined time period has elapsed. For example, the processes may be repeated after projection of the pattern onto a substrate W has been completed. This is indicated by a dotted line which connects the last process to the first process.

It may be desired to repeat the series of processes shown in FIG. 7 after exposure of each substrate. This may for example continue until the measured aberration is found to be unchanging; indicating that the temperature of the lens has stabilized.

It may be desired to repeat the series of processes less often, for example after exposure of every second substrate, or of every third substrate, or after some other number of substrates. Since the rate of increase of the lens temperature decays over time, the time period between repeats of the process series may increase. For example, the process may be performed after exposure of the first substrate, third substrate, sixth substrate, etc.

References to particular processes being performed by particular entities are examples only, and it may be the case that some processes are performed by other entities. Additionally or alternatively, one or more processes may be performed by a single entity. For example, in addition to calculating the adjustment of the illumination mode, the processor PR may also calculate the control signals to be applied to the mirrors.

The adjustments of the illumination mode are not changes between different types of mode, for example between quadrupole and annular illumination modes. Instead, the type of illumination mode remains the same, and a property of that illumination mode is adjusted. For example, the illumination mode may be stretched in a particular direction, may be made larger, made smaller, etc.

The processor PR may for example use a program known as LithoGuide, available from ASML, Veldhoven, Netherlands. LithoGuide is modelling software which includes a representation of lens heating, and the effect of lens heating upon projected patterns.

The effect of lens heating upon the projected pattern may for example be based upon a model which includes the following equation:

$$B = {\sum }_{i} {S}_{i} {Z}_{i}$$

where B is the width of a feature such as a trench (a critical dimension measurement), Zᵢ indicates different orders of aberration, and Sᵢ is a measure of sensitivity to a given order of aberration.

In the above described embodiment of the invention the desired adjustment of the illumination mode is calculated in real time, i.e. immediately after an aberration measurement has been obtained. In an alternative approach, a calibration run may be performed in advance, to allow suitable adjustments of the illumination mode to be calculated in advance of a production run. The calibration run may for example comprise a series of 25 substrates, the aberration present in the radiation beam being measured using the detector DT after each substrate. Following the calibration run, the processor PR is used to determine for each measured set of data the effect of the aberration on the projected pattern, and an appropriate adjustment of the illumination mode to reduce this effect. Calibration runs may be performed for different illumination modes, and may also be performed for illumination modes of a given type but having different properties. Calibration runs may also be performed for different patterns or different types of pattern.

During a subsequent production run, an appropriate illumination mode is selected for the pattern provided on the mask MA. The results of a calibration run which was performed for this illumination mode are retrieved from a memory. These results are used, via the controller CT, to control the orientation of the mirrors of the mirror array in the illuminator IL. This provides adjustment of the illumination mode to reduce the effect of lens heating on the projected pattern. The adjustment is provided without having to measure the aberration of the radiation beam between exposure of substrates, and without having to calculate adjustments between exposures.

In a further alternative arrangement, the adjustments of the illumination mode may be determined via one or more calibration runs, and saved as a set of data. During a subsequent production run, the aberration may be measured after exposure of a substrate. The measured aberration may be compared with the set of data to find the most similar stored aberration. The appropriate illumination mode adjustment is then retrieved from the stored data and is applied to the illumination mode.

In general, the embodiment of the invention provides correction of aberration caused by lens heating via adjustment of the illumination mode.

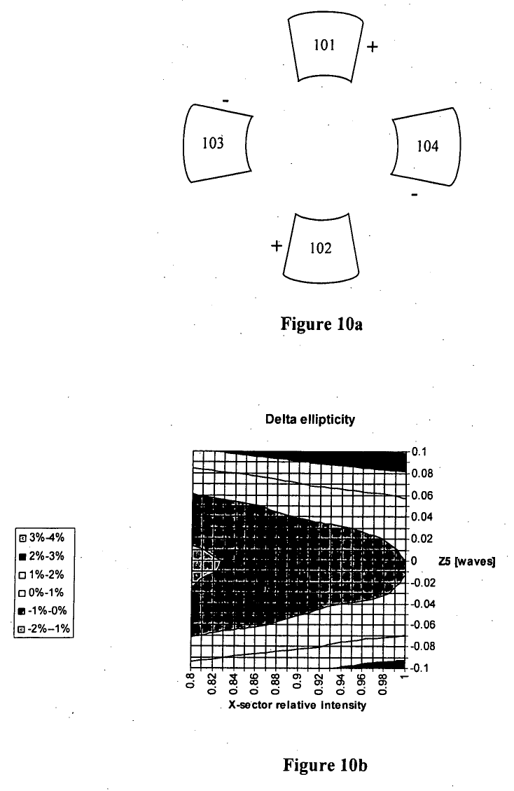

FIGS. 8a and 8b show schematically an adjustment of a quadrupole illumination mode, and the effect of that adjustment. The quadrupole illumination mode comprises four poles which for the purposes of this description will be referred to as the upper pole 101, the lower pole 102, left-hand pole 103, and right-hand pole 104. FIG. 8b shows, viewed from above, a contact hole 105 which is to be projected onto a substrate.

In the situation shown in FIGS. 8a and 8b, the contact hole 105 is elliptical (due to aberrations in the radiation beam caused by lens heating), whereas it is intended to be circular. The contact hole 105 therefore needs to be stretched in the direction indicated by the double-headed arrow. This is achieved by modifying the upper and lower poles 101, 102 of the quadrupole mode. The modification comprises stretching the upper and lower poles 101, 102 as indicated by the double-headed arrows in FIG. 8a. The degree to which the poles are to be stretched is determined by the processor PR as described further above. The left and right-hand poles 103, 104 are not modified, and therefore remain the same.

A distortion of the type shown in FIGS. 8a and 8b may for example arise due to an increase in the amount of so called Z5 aberration present in the radiation beam. The adjustment of the illumination mode minimizes the effect of the Z5 aberration.

FIGS. 9a and 9b show schematically a quadrupole illumination mode. As shown in FIG. 9a, an adjustment which may be made to the illumination mode comprises moving the left and right-hand poles 103, 104 closer together. FIG. 9b shows the impact of the Z5 aberration, and illustrates how adjustment of the positions of the left and right-hand poles may be used to minimize the effect of this aberration. In FIG. 9b, it is preferred to be on the transition between the dark grey region and the white region. When no Z5 aberration is present, the preferred distance between the center of the illumination mode and the outer edges of the left and right-hand poles 103, 104 is 0.8 (expressed as a fraction of the numerical aperture). However, once some Z5 aberration is introduced, the preferred distance between the center of the illumination mode and the outer edges of the left and right-hand poles 103, 104 reduces. For example, when Z5 is 0.04, the preferred distance is approximately 0.74. The reduction of the distance may be achieved by moving together the left and right-hand poles 103, 104 of the illumination mode, as shown schematically by arrows in FIG. 9a.

FIGS. 10a and 10b illustrate an alternative adjustment of the illumination mode which may be used to minimize the effect of aberrations. Referring to FIG. 10b, the relative intensities of the so-called x-sector poles (i.e. the left and right-hand poles 103,104) are illustrated compared with the so-called y-sector poles (i.e. the upper and lower poles 101, 102). In common with FIG. 9b, it is preferred to stay at the transition between the dark grey region and the white region. It can be seen from FIG. 10b that when there is no Z5 aberration present, the ratio of intensities in the x and y sectors may be 1, i.e. the same amount of energy is present in the left and right-hand poles 103, 104 as is present in the upper and lower poles 101, 102. However, when some Z5 aberration is present in the radiation, an adjustment of the relative intensities in the poles is needed. For example, when Z5=0.04, the relative intensities of the poles 101-104 are adjusted such that the intensity of the x-sector poles (left and right hand poles 103, 104) is approximately 0.89 of the intensity of the y-sector poles (upper and lower poles 101, 102).

Other adjustments of the illumination mode which may be used to reduce the effect of lens heating on a projected pattern include changing the shape of the poles (for example tapering the intensity at edges of the poles), moving the inner edge of the poles, and moving the outer edge of the poles, the sigma inner and outer (i.e. make ring wider/smaller).

Although the illumination mode adjustments have been described in relation to poles, at least some of the adjustments may be applied to mode types which do not comprise poles. For example, adjustments may be applied to an annular mode, disc mode, etc.

The adjustment of the illumination mode is intended to mean a modification of the illumination mode without changing the illumination mode type (i.e. it is not intended to include for example switching between a quadrupole mode and an annular mode). The adjustment of the illumination mode may be considered to be an adjustment of the angular distribution of the radiation beam.

Although embodiments of the invention have been described above in relation to a mirror array, any other suitable array of individually controllable elements may be used.

While specific embodiments of the invention have been described above, it will be appreciated that the invention may be practiced otherwise than as described. The description is not intended to limit the invention.

The present listing of claims replaces all prior versions, and listings, of the claims in the application:

1. A lithographic method comprising:
using an illumination system to provide a beam of radiation having an illumination mode;
imparting the beam of radiation with a pattern in its cross-section;
projecting the patterned radiation beam onto a plurality of substrates; and
adjusting the illumination mode after the beam has been projected onto one or more substrates, the adjustment being arranged to reduce an effect of aberrations on the pattern due to lens heating during projection of the pattern onto one or more subsequent substrates.

2. The method of claim 1, wherein the aberrations are measured using a detector.

3. The method of claim 1, wherein the aberrations are estimated.

4. The method of claim 1, wherein the adjustment of the illumination mode is calculated and includes determining the effect of aberrations on the pattern that is projected.

5. The method of claim 1, wherein the adjustment of the illumination mode is calculated after projection of the beam onto the one or more substrates.

6. The method of claim 1, wherein the adjustment of the illumination mode is calculated before beginning projection of the patterned radiation beam onto the plurality of substrates, and is retrieved from a storage device.

7. The method of claim 1, wherein the illumination system comprises an array of individually controllable elements and associated optical components arranged to provide the illumination mode, the method further comprising adjusting the controllable elements in order to provide the adjustment of the illumination mode.

8. The method of claim 1, wherein the adjustment of the illumination mode comprises stretching one or more poles of the illumination mode.

9. The method of claim 1, wherein the adjustment of the illumination mode comprises changing a separation between one or more poles of the illumination mode.

10. The method of claim 1, wherein the adjustment of the illumination mode comprises changing relative intensities of poles of the illumination mode.

11. The method of claim 1, wherein the adjustment of the illumination mode comprises changing an inner or outer boundary of the illumination mode.

12. The method of claim 1, wherein the adjustment of the illumination mode comprises tapering an intensity of radiation at edges of the illumination mode.

13. A lithographic apparatus comprising:
an illumination system for providing a beam of radiation having an illumination mode;
a support structure for supporting a patterning device, the patterning device serving to impart the beam with a pattern in its cross-section;
a substrate table for holding a substrate;
a projection system for projecting the patterned radiation beam onto a target portion of the substrate; and
a controller arranged to control part of the illumination system, the controller being arranged to adjust the illumination mode of the beam after the beam has been projected onto one or more substrates, the adjustment being arranged to reduce an effect of aberration on the pattern due to lens heating during projection of the pattern onto one or more subsequent substrates.

14. The apparatus of claim 13, wherein the apparatus further comprises a detector arranged to measure the aberration.

15. The apparatus of claim 13, wherein the apparatus further comprises a memory arranged to store a plurality of illumination mode adjustments linked to a plurality of aberration values.

16. The apparatus of claim 13, wherein the illumination system comprises an array of individually controllable elements and associated optical components arranged to provide the illumination mode, and the controller is arranged to control the individually controllable elements of the array in order to provide the adjustment of the illumination mode.

17. The apparatus of claim 13, wherein the controller is arranged to perform at least one of:
stretching one or more poles of the illumination mode;
changing a separation between one or more poles of the illumination mode;
changing relative intensities of poles of the illumination mode;
changing an inner or outer boundary of the illumination mode; or
tapering an intensity of radiation at edges of the illumination mode.

18. A lithographic method comprising
using an illumination system to provide a beam of radiation having an illumination mode;
using a patterning device to impart the radiation beam with a pattern in its cross-section; and
projecting the patterned radiation beam onto a plurality of substrates;
wherein the illumination mode is adjusted after the radiation beam has been projected onto one or more substrates, the adjustment being arranged to reduce the effect of aberrations due to lens heating on the projected pattern during projection of the pattern onto one or more subsequent substrates.

19. The method of claim 18, wherein the aberrations are measured using a detector.

20. The method of claim 18, wherein the aberrations are estimated.

21. The method of claim 18, wherein calculation of the adjustment of the illumination mode includes determining the effect of aberrations on the projected pattern.

22. The method of claim 18, wherein the adjustment of the illumination mode is calculated after the projection of the radiation beam onto the one or more substrates.

23. The method of claim 18, wherein the adjustment of the illumination mode is calculated before beginning projection of the patterned radiation beam onto the plurality of substrates, and is retrieved from a storage device.

24. The method of claim 18, wherein the illumination system comprises an array of individually controllable elements and associated optical components arranged to provide the illumination mode, the method further comprising adjusting the elements in order to provide the adjustment of the illumination mode.

25. The method of claim 18, wherein the adjustment of the illumination mode comprises stretching one or more poles of the illumination mode.

26. The method of claim 18, wherein the adjustment of the illumination mode comprises changing the separation between one or more poles of the illumination mode.

27. The method of claim 18, wherein the adjustment of the illumination mode comprises changing the relative intensities of poles of the illumination mode.

28. The method of claim 18, wherein the adjustment of the illumination mode comprises changing an inner or outer boundary of the illumination mode.

29. The method of claim 18, wherein the adjustment of the illumination mode comprises tapering the intensity of radiation at edges of the illumination mode.
